(19) United States
(12) Patent Application Publication
(10) Pub. No.: US 2023/0367928 A1
(43) Pub. Date: Nov. 16, 2023

(54) SYSTEM AND METHOD TO AUTOMATICALLY GENERATE AND OPTIMIZE RECYCLING PROCESS PLANS FOR INTEGRATION INTO A MANUFACTURING DESIGN PROCESS

(71) Applicant: Siemens Corporation, Washington, DC (US)

(72) Inventors: Joseph Tylka, Pennington, NJ (US); Arquimedes Martinez Canedo, Plainsboro, NJ (US); Sanjeev Srivastava, Chantilly, VA (US); Kashish Goyal, Plainsboro, NJ (US); Annemarie Breu, Lawrenceville, NJ (US)

(73) Assignee: Siemens Corporation, Washington, DC (US)

(21) Appl. No.: 18/043,915

(22) PCT Filed: Aug. 31, 2021
(86) PCT No.: PCT/US2021/048313

§ 371 Date: Mar. 3, 2023

Related U.S. Application Data
(60) Provisional application No. 63/074,049, filed on Sep. 3, 2020.

(51) Int. Cl. G06F 30/20

(52) U.S. Cl. CPC G06F 30/20; G06F 2119/20

(57) ABSTRACT

System and method optimize recyclability of an electronic device during manufacturing design A manufacturing design software produces engineering bill of materials, manufacturing bill of materials, and bill of process for the manufacturing design. Recycling process plan engine constructs a recycling process plan for the electronic device according to the manufacturing design. A virtual model of recycling processes is constructed by mapping needed skills to corresponding recycling equipment using a library of recycling equipment information. Recycling process plan engine uses the virtual model to simulate the recycling plan and optimizes each recycling process, and the overall sequence of recycling processes, according to an objective function. Evaluator module receives key performance indicator values from a virtual model simulation and calculates the value of the objective function based on key performance indicators. Recycling plan is optimized by iteration of simulating the process and varying parameters to most improve the objective function.

### TECHNICAL FIELD

This application relates to recycling e-waste and manufacturing design of electronic devices. More particularly, this application relates to automatic generation of a recycling process plan (RPP) for an electronic device and integration of the RPP generation process into the manufacturing design process for the same electronic device.

### BACKGROUND

It is estimated that over 50 million metric tons of electronic waste (e-waste) is generated annually worldwide, with only about 20% of it being recycled. End-of-life (EoL) processing plans are typically determined empirically by recycling experts through testing samples of the EoL product with their available recycling equipment and machines. Success in achieving higher recycling rates would be improved if the design process for manufacture of the electronic device were to account and plan for the recycling of the device at EoL.

Recycling equipment is used by trained experts to convert batches of manufactured products into their constituent elements (so-called recyclates). The operators' experience guides their operation of the machines and scheduling of the processes for a given product. Typical recycling processes include: separation, sorting, shredding, disassembly, removal, grinding, dismantling, extraction, etc. Process modeling tools exist that can be used to model the recycling process and equipment, but such modeling tools still require manual planning of each step in the recycling process by domain experts.

### SUMMARY

A system and method are proposed to automatically generate and evaluate recycling process plans (RPPs), which describe the sequence of recycling processes and corresponding equipment needed to recycle a given manufactured product or component (e.g., a smart phone, any other electronic device) at the end of its life. These RPPs are analogous to a manufacturing bill of materials & bill of process (mBOM/BOP) and can be directly generated at design time given only the design (e.g., CAD model), manufacturing plans, and material data for the product.

An RPP can be evaluated in terms of different recyclability performance metrics (e.g., fraction of material recovered, amount of waste generated, total energy consumed in process), and subsequently optimized to meet different recycling objectives for the product (e.g., most material recovered, efficient removal of high-value components, etc.). The optimized RPP can then be used by recycling facility operators to plan and execute the recycling task.

In an aspect, a system is provided for optimizing recyclability of an electronic device during manufacturing design. A manufacturing design software produces an engineering bill of materials, a manufacturing bill of materials, and a bill of process for the manufacturing design. A recycling process planning engine automatically generates one or more recycling process plans for the electronic device according to the manufacturing design. A virtual model of the recycling processes is constructed by mapping needed recycling “skills” (e.g., shredding, grinding, etc.) to corresponding recycling equipment using a library of recycling equipment information. The recycling process planning engine uses the virtual model to simulate the recycling plan and optimizes each recycling process according to at least one objective function. An evaluator module receives key performance indicator (KPI) values from a simulation of the virtual model and calculates the value of the objective function based on the key performance indicators. The recycling plan is optimized by iteration of simulating and varying parameters to improve the value of the objective function. The recycling process planning engine provides feedback to the manufacturing design software tool with recommended modifications to one or more of the engineering bill of materials, manufacturing bill of materials, and bill of process for optimizing recyclability of the product.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of a system and process for optimizing recyclability of a an electronic device or similar product in accordance with embodiments of the disclosure.

FIG. 2 shows an example of a computing environment within which embodiments of the disclosure may be implemented.

### DETAILED DESCRIPTION

System and method to automatically generate and evaluate recycling process plans for integration into a manufacturing design is disclosed. A recycling process plan engine builds a virtual model of one or more recycling process plans which can be optimized for one or more objective parameters, such as recovering as much recyclable material as possible. According to the generated recycling plan(s), a manufacturing design (e.g., choice of product materials and sequence of assembly processes) can be altered in real time using feedback from the recycling plan model so that the manufactured product can be efficiently recycled when reaching end of life.

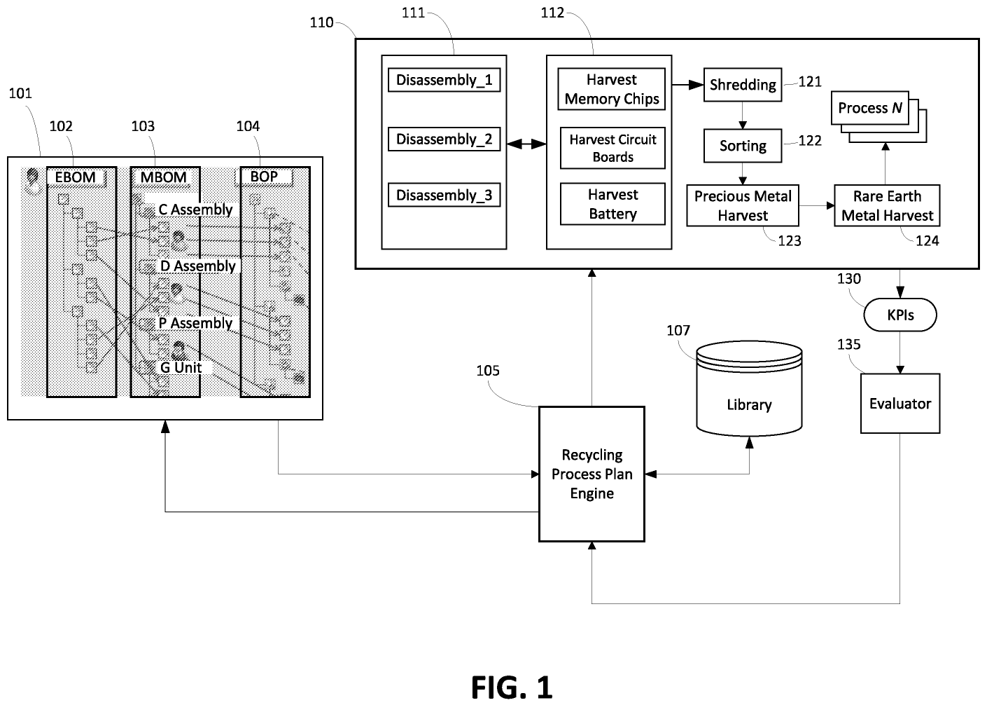

FIG. 1 shows an example of a system and process for optimizing recyclability of a manufacturing design of an electronic device in accordance with embodiments of the disclosure. A manufacturing design software tool 101 is operated by a user, such as a designer or engineer, to generate a manufacturing process for a product, such as an electronic device, to be constructed of recyclable materials to reduce electronic waste at end of life for the device. Manufacturing design software tool 101 is configured to generate an engineering plan and a manufacturing plan. An engineering bill of materials (EBOM) 101 relates to how a product is to be designed and a manufacturing bill of materials (MBOM) 102 contains the components and assemblies required to build the final product. MBOM 102 may include equipment requirements describing the machines and tools required to make the product. A bill of process (BOP) 103 for the manufacturing design is based on the MBOM 102 and material data for the product and describes the manufacturing and assembly process.

Recycling process plan engine 105 is configured as a software tool that performs custom modeling for simulating complex systems in a flowsheet environment and data regression solver for parameter estimation. In an embodiment, recycling process plan engine 105 is configured with physics solvers that apply ordinary differential equations for linear physics problems and/or partial differential equations for multivariable problems and multidimensional systems. Examples of particular physics may include the physics of breakage or granulation during shredding (i.e., how many particles and of what size and shape distributions will be created if shredding material X at speed Y). Similarly, each recycling process may have one or more related physics problems to solve for independent optimization. Equipment parameters for the recycling process are optimized using distributed process models. Continuous and discrete variables for steady-state and dynamic processes can be optimized. A user interface enables a user to set and change variables for modeling a custom recycling process.

Information from EBOM 101 and MBOM 102, and BP 103 are useful for determining how a device is assembled, and from this information, recycling process plan engine 105 formulates a disassembly plan to be performed by a disassembly robot 111. For example, disassembly robot 111 may be configured to execute multiple disassembly processes, shown as Disassemble_1, Disassemble_2, Disassemble_3. representing different sets of fastener removals (e.g., screws that secure the external casing, fasteners that secure internal components, ribbon wire connectors, or the like). In an embodiment, assembly information may be in the form of connectivity diagrams, which can be traced by recycling process plan engine 105 in reverse to generate a disassembly plan and sequence of operations for disassembly robot 111. Using library 107 of recycling process tools, a recycling process plan engine 105 creates a virtual model 110 for the recycling process plan, including identification of disassembly robot 111 and other recycling equipment and processes, which may include harvesting robot 112, shredding equipment configured to perform shredding processes 121, sorting equipment configured to perform sorting processes 122, materials harvesting equipment configured to perform material harvesting processes such as precious metal harvesting processes 123, rare earth metal harvesting processes 124. Various other recycling equipment may also be modeled to perform other recycling processes needed to recycle a given manufactured product or component (e.g., laptop computer, smart phone, or other electronic device).

In an embodiment, recycling process plan engine 105 optimizes the operation of the disassembly robot 111 related to sequence of fastener removal for speed and efficiency in the disassembly process. In addition, operating parameters for the disassembly robot 111 may be optimized according to key performance indicators (KPIs).

Harvesting robot 112 may be implemented by a robot programmed to extract components of the electronic device that are preferred to remain intact, such as components that can be reconditioned or components that should not be shredded for safety reasons (e.g., a lithium battery). Other uses for harvesting components may include efficiency in the material separation process by separating prior to shredding (e.g., circuit boards, memory chips, processors, integrated circuits, or the like). In an embodiment, recycling process plan engine 105 optimizes operation of the harvesting robot 112 related to the sequence of harvesting for speed and efficiency in the recycling process. For example, optimal sequence for the recycling process plan performs a trade-off comparison between a first option that leaves some low-value circuit boards still connected to each other for removal all at once for discarding them, and a second option that disassembles each component in a sequence to harvest one key part. The trade-off analysis by recycling process plan engine estimates the value in disassembling the whole subsystem just to remove one chip. In addition, operating parameters for the harvesting robot 111 may be optimized according to KPIs.

From identified recycling process equipment, recycling process plan engine 105 stitches the recycling equipment into the virtual model 110 according to a candidate sequence of recycling processes. An objective is to run the recycling process plan engine 105 in parallel with the manufacturing design process to provide useful feedback and guidance for improving the design with respect to recyclability. In an embodiment, recycling process plan engine 105 automatically explores the possible combinations and sequences of available recycling processes to identify suitable candidates as recycling plans. Only plans that are logically plausible are included in this step. For instance, a recycling plan that includes magnetic separation must always have a sequence in which shredding precedes magnetic separation.

Library 107 may include a knowledge base of recycling process components and equipment, as well as sequences for recycling processes that were applied in earlier projects by recycling process plan engine 105. Data in library 107 may also include skill sets mapped to recycling equipment and components. For example, the recycling process virtual model 110 may be constructed by recycling process plan engine 105 according to a definition of needed skills and then mapping the corresponding equipment to the needed skills. Library 107 may also include performance metrics or KPIs (e.g., total fraction of each input material recovered, total energy expended in the recycling process, total time taken to process a single unit, etc.) defined for each recycling component by recycling process plan engine 105. In an embodiment, each step of the recycling process may be modeled according to the mapped skill set, then the sequence of each step is optimized according to operating parameters for each step. For example, an objective parameter may be to maximize volume of recovered recyclable material and/or to minimize the volume of lost recyclable material during any of the recycling process steps.

The candidate recycling plans are evaluated by evaluator module 135 based on various performance metrics or KPIs 130. These individual KPIs 130 can then be combined by evaluator module 135 into an objective function (e.g., by a weighted linear combination of the individual KPIs), such that parameters of the recycling process can be optimized to minimize (or maximize) that objective function. For example, operating parameters of a shredder with variable speed or blade spacing can be optimized to increase the fraction of recovered material from the recycled product while minimizing time and energy spent in the process. Output of evaluator 135 includes one or more objective functions which are fed back to recycling process plan engine 105 for further iterations of recycling process building to optimize the performance of each recycling process and possibly reorder the sequence of the recycling process plan as arranged in virtual model 110.

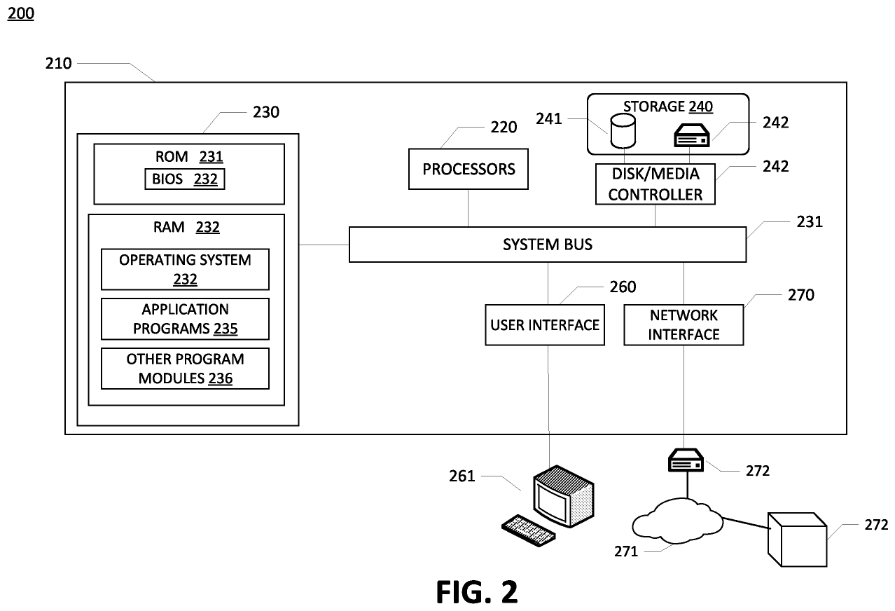

FIG. 2 illustrates an example of a computing environment within which embodiments of the present disclosure may be implemented. A computing environment 200 includes a computer system 210 that may include a communication mechanism such as a system bus 221 or other communication mechanism for communicating information within the computer system 210. The computer system 210 further includes one or more processors 220 coupled with the system bus 221 for processing the information. In an embodiment, computing environment 200 corresponds to recycling process plan development and manufacturing design optimization for recyclability, in which the computer system 210 relates to a computer described below in greater detail.

The processors 220 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 220 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 221 may include at least one of a system bus, a memory bus, an address bus, or a message bus, and may permit exchange of information (e.g., data (including computer-executable code), signaling, etc.) between various components of the computer system 210. The system bus 221 may include, without limitation, a memory bus or a memory controller, a peripheral bus, an accelerated graphics port, and so forth. The system bus 221 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 2, the computer system 210 may also include a system memory 230 coupled to the system bus 221 for storing information and instructions to be executed by processors 220. The system memory 230 may include computer readable storage media in the form of volatile and/or nonvolatile memory, such as read only memory (ROM) 231 and/or random access memory (RAM) 232. The RAM 232 may include other dynamic storage device(s) (e.g., dynamic RAM, static RAM, and synchronous DRAM). The ROM 231 may include other static storage device(s) (e.g., programmable ROM, erasable PROM, and electrically erasable PROM). In addition, the system memory 230 may be used for storing temporary variables or other intermediate information during the execution of instructions by the processors 220. A basic input/output system 233 (BIOS) containing the basic routines that help to transfer information between elements within computer system 210, such as during start-up, may be stored in the ROM 231. RAM 232 may contain data and/or program modules that are immediately accessible to and/or presently being operated on by the processors 220. System memory 230 may additionally include, for example, operating system 234, application modules 235, and other program modules 236. Application modules 235 may include aforementioned modules described for FIG. 1, such as recycling process plan engine 105 and evaluator 135, and may also include a user portal for development of the application program, allowing input parameters to be entered and modified as necessary.

The operating system 234 may be loaded into the memory 230 and may provide an interface between other application software executing on the computer system 210 and hardware resources of the computer system 210. More specifically, the operating system 234 may include a set of computer-executable instructions for managing hardware resources of the computer system 210 and for providing common services to other application programs (e.g., managing memory allocation among various application programs). In certain example embodiments, the operating system 234 may control execution of one or more of the program modules depicted as being stored in the data storage 240. The operating system 234 may include any operating system now known or which may be developed in the future including, but not limited to, any server operating system, any mainframe operating system, or any other proprietary or non-proprietary operating system.

The computer system 210 may also include a disk/media controller 243 coupled to the system bus 221 to control one or more storage devices for storing information and instructions, such as a magnetic hard disk 241 and/or a removable media drive 242 (e.g., floppy disk drive, compact disc drive, tape drive, flash drive, and/or solid state drive). Storage devices 240 may be added to the computer system 210 using an appropriate device interface (e.g., a small computer system interface (SCSI), integrated device electronics (IDE), Universal Serial Bus (USB), or FireWire). Storage devices 241, 242 may be external to the computer system 210.

The computer system 210 may include a user interface 260 for communication with a graphical user interface (GUI) 261, which may comprise one or more input/output devices, such as a keyboard, touchscreen, tablet and/or a pointing device, for interacting with a computer user and providing information to the processors 220, and a display screen or monitor. In an aspect, the GUI 261 relates to the user interface driven by recycling process plan engine 105 in FIG. 1 as earlier described.

The computer system 210 may perform a portion or all of the processing steps of embodiments of the invention in response to the processors 220 executing one or more sequences of one or more instructions contained in a memory, such as the system memory 230. Such instructions may be read into the system memory 230 from another computer readable medium of storage 240, such as the magnetic hard disk 241 or the removable media drive 242. The magnetic hard disk 241 and/or removable media drive 242 may contain one or more data stores and data files used by embodiments of the present disclosure. The data store 240 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 220 may also be employed in a multi-processing arrangement to execute the one or more sequences of instructions contained in system memory 230. In alternative embodiments, hard-wired circuitry may be used in place of or in combination with software instructions. Thus, embodiments are not limited to any specific combination of hardware circuitry and software.

As stated above, the computer system 210 may include at least one computer readable medium or memory for holding instructions programmed according to embodiments of the invention and for containing data structures, tables, records, or other data described herein. The term “computer readable medium” as used herein refers to any medium that participates in providing instructions to the processors 220 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 241 or removable media drive 242. Non-limiting examples of volatile media include dynamic memory, such as system memory 230. Non-limiting examples of transmission media include coaxial cables, copper wire, and fiber optics, including the wires that make up the system bus 221. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to illustrations of methods, apparatus (systems), and computer program products according to embodiments of the disclosure. It will be understood that each block of the illustrations, and combinations of blocks in the illustrations, may be implemented by computer readable medium instructions.

The computing environment 200 may further include the computer system 210 operating in a networked environment using logical connections to one or more remote computers, such as remote computing device 273. The network interface 270 may enable communication, for example, with other remote devices 273 or systems and/or the storage devices 241, 242 via the network 271. Remote computing device 273 may be a personal computer (laptop or desktop), a mobile device, a server, a router, a network PC, a peer device or other common network node, and typically includes many or all of the elements described above relative to computer system 210. When used in a networking environment, computer system 210 may include modem 272 for establishing communications over a network 271, such as the Internet. Modem 272 may be connected to system bus 221 via user network interface 270, or via another appropriate mechanism.

Network 271 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 210 and other computers (e.g., remote computing device 273). The network 271 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 271.

It should be appreciated that the program modules, applications, computer-executable instructions, code, or the like depicted in FIG. 2 as being stored in the system memory 230 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 210, the remote device 273, and/or hosted on other computing device(s) accessible via one or more of the network(s) 271, may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

It should further be appreciated that the computer system 210 may include alternate and/or additional hardware, software, or firmware components beyond those described or depicted without departing from the scope of the disclosure. More particularly, it should be appreciated that software, firmware, or hardware components depicted as forming part of the computer system 210 are merely illustrative and that some components may not be present or additional components may be provided in various embodiments. While various illustrative program modules have been depicted and described as software modules stored in system memory 230, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The block diagrams in the Figures illustrate the architecture, functionality, and operation of possible implementations of systems, methods, and computer program products according to various embodiments of the present disclosure. In this regard, each block in the block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams illustration, and combinations of blocks in the block diagrams illustration, can be implemented by special purpose hardware-based systems that perform the specified functions or acts or carry out combinations of special purpose hardware and computer instructions.

What is claimed is:

1. A system for optimizing recyclability of a manufacturing design of an electronic device, comprising:
a memory having modules stored thereon; and
a processor for performing executable instructions in the modules stored on the memory, the modules comprising:
a manufacturing design software tool configured to produce an engineering bill of materials, a manufacturing bill of materials, and a bill of process for the manufacturing design;
a recycling process plan engine configured to construct a recycling process plan for the electronic device, wherein constructing the recycling process plan comprises:
generating a virtual model of recycling processes using information from a library of recycling equipment information by mapping needed skills to corresponding recycling equipment;
defining key performance indicators for each recycling process;
simulating the recycling process plan using the virtual model; and
optimizing each recycling process according to at least one objective function; and
an evaluator module configured to:
receive key performance indicator values from a simulation of the virtual model; and
generate the at least one objective function based on the key performance indicators;
wherein the recycling process plan engine is further configured to:
iterate the simulating and optimizing with parameters adjusted by the objective function; and
provide feedback to the manufacturing design software tool with recommended modifications to one or more of the engineering bill of materials, manufacturing bill of materials and bill of process for optimizing recyclability of the manufacturing design.

2. The system of claim 1, wherein the recycling process plan engine is further configured to:
assemble the virtual model by stitching together each recycling process in a sequence; and
optimize the sequence according to at least one objective function.

3. The system of claim 1, wherein the at least one objective function includes maximizing volume of recyclable material.

4. The system of claim 1, wherein the at least one objective function includes minimizing volume of lost recyclable material.

5. The system of claim 1, wherein the recycling process plan engine is further configured to optimize operation of a disassembly robot related to sequence of fastener removal.

6. The system of claim 5, wherein the recycling process plan engine is further configured to optimize operation of a harvesting robot related to sequence of harvesting parts or components of the electronic device during disassembly.

7. The system of claim 1, wherein the recycling processes include one or more of shredding processes, sorting processes, and materials harvesting processes.

8. A computer based method for optimizing recyclability of a manufacturing design of an electronic device, comprising:
producing, by a manufacturing design software tool, an engineering bill of materials, a manufacturing bill of materials, and a bill of process for the manufacturing design;
constructing a recycling process plan for the electronic device, wherein constructing the recycling process plan comprises:
generating a virtual model of recycling processes using information from a library of recycling equipment information by mapping needed skills to corresponding recycling equipment;
defining key performance indicators for each recycling process;
simulating the recycling process plan using the virtual model; and
optimizing each recycling process according to at least one objective function;
receiving key performance indicator values from a simulation of the virtual model;
generating the at least one objective function based on the key performance indicators;
iterating the simulating and optimizing with parameters adjusted by the objective function; and
providing feedback to the manufacturing design software tool with recommended modifications to one or more of the engineering bill of materials, manufacturing bill of materials and bill of process for optimizing recyclability of the manufacturing design.

9. The method of claim 8, further comprising:
assembling the virtual model by stitching together each recycling process in a sequence; and
optimizing the sequence according to at least one objective function.

10. The method of claim 8, wherein the at least one objective function includes maximizing volume of recyclable material.

11. The method of claim 8, wherein the at least one objective function includes minimizing volume of lost recyclable material.

12. The method of claim 8, further comprising optimizing operation of a disassembly robot related to sequence of fastener removal.

13. The system of claim 12, further comprising optimizing operation of a harvesting robot related to sequence of harvesting parts or components of the electronic device during disassembly.

14. The method of claim 8, wherein the recycling processes include one or more of shredding processes, sorting processes, and materials harvesting processes.
